(19) United States
(12) Patent Application Publication
(10) Pub. No.: US 2022/0050841 A1
(43) Pub. Date: Feb. 17, 2022

(54) ISOMETRIC TRANSFORMATIONS OF DIRECT SEARCH MESH

(71) Applicants: Benjamin Alexander Albert, Columbia, MD (US); Arden Qiyu Zhang, Clarksville, MD (US)

(72) Inventors: Benjamin Alexander Albert, Columbia, MD (US); Arden Qiyu Zhang, Clarksville, MD (US)

(21) Appl. No.: 17/151,526

(22) Filed: Jan. 18, 2021

Related U.S. Application Data
(60) Provisional application No. 63/064,573, filed on Aug. 12, 2020.

(51) Int. Cl. G06F 16/2453

(52) U.S. Cl. CPC G06F 16/24534

(57) ABSTRACT

A computerized optimization method, system, and computer readable storage medium for performing pattern searching includes (a) providing an initial mesh of vectors; (b) providing initial points to be used as a base vector establishing a center region of the mesh of vectors; (c) for each base vector, obtaining a transformed mesh via an isometric transformation of the initial mesh of vectors; (d) evaluating the model objective function via each transformed mesh of vectors; (e) selecting a next set of base vectors by selecting a most favorable set of transformed mesh vectors to correspond with the objective function; (f) repeating steps (c) through (e) in an iterative sequence until a termination criterion of the iterative sequence is met; and (g) storing the selected most favorable transformed mesh vectors in a memory.

### CROSS-REFERENCE TO RELATED APPLICATIONS

This application claims priority to U.S. Provisional Patent Application No. 63/064,573 filed on Aug. 12, 2020, the complete disclosure of which, in its entirety, is herein incorporated by reference.

### BACKGROUND

### Technical Field

The embodiments herein generally relate to search algorithms and optimizations, and more particularly to computer pattern search optimization techniques of a direct search mesh.

### Description of the Related Art

There are several types of optimization subfields such as global optimizers of nonlinear programming problems. In this context, optimization is generally the process by which an n-dimensional vector is found that minimizes an objective function. Such vectors are called solutions, and specific solution classifications are commonly called local minima or global minima. Local minima are solutions whereby neighboring solutions in all dimensions yield greater objective function values, but solutions are only considered global if and only if there are no other points in the domain that yield an objective function value less than the global minima point. If no other point yields a value less than or equal to, then the global minima is considered a strict extremum.

Often the domain of objective functions is bounded. For example, n-dimensional rectangular prism domain bounds may be defined and represented as: ∃{\vec{a},\vec{b}∈ [symbol] ⁿ} such that xᵢ∈[aᵢ,bᵢ]∀i∈[1, n]. Other constraints may be imposed; for example, the optimization may be subject to equality or inequality constraint functions that further limit the feasible region.

Consider the optimization of the general form min ƒ(x), ƒ: [symbol] ⁿ→ [symbol] where ƒ(\vec{x}) is called the objective function. Other names exist for the objective function, including, but not limited to: objective value function, loss function, cost function, utility function, fitness function, and energy function. Optimization involves processes that ultimately yield one or more solution vectors that attempt to minimize ƒ(\vec{x}). It is worth noting that minimization encompasses maximization by processing the negative of the objective function: max ƒ(\vec{x}) is achievable by min−ƒ(\vec{x}). There are also tangential problems comprised of any combination of: one or more objective functions, equality constraints, and inequality constraints. Multi-objective optimization, also called multi-objective programming, vector optimization, multicriteria optimization, multi-attribute optimization, and Pareto optimization, often involves trade-offs between the multiple objective functions such that a solution vector that improves the output of an objective function can worsen the output of another. Multi-objective optimization can be encompassed in single objective optimization by considering the outputs of multiple objective functions as the inputs to a single objective function. For example, the multi-objective problem min g(\vec{x}) and min h(\vec{x}), can be expressed as a single objective problem: min ƒ(g(\vec{x}),h(\vec{x})).

Challenges in Optimization

Optimization is often challenging for several reasons such as: the domain space increases exponentially with respect to dimensionality; many local minima can exist, which can trap algorithms and prevent further exploration of the domain; and objective functions can be unconstrained, non-differentiable, discontinuous, and/or subject to randomness. The conventional solutions often suffer from: inefficient scalability with respect to dimensionality; tendencies to get stuck in local minima; insufficient exploration of the search space; stochasticism and non-determinism; computational demand; and the use of derivatives information, among other drawbacks and deficiencies.

### SUMMARY

In view of the foregoing, an embodiment herein provides a computerized optimization method for performing pattern searching, the method comprising (a) providing an initial mesh of vectors; (b) providing initial points to be used as a base vector establishing a center region of the mesh of vectors; (c) for each base vector, obtaining a transformed mesh via an isometric transformation of the initial mesh of vectors; (d) evaluating the model objective function via each transformed mesh of vectors; (e) selecting a next set of base vectors by selecting a most favorable set of transformed mesh vectors to correspond with the objective function; (f) repeating steps (c) through (e) in an iterative sequence until a termination criterion of the iterative sequence is met; and (g) storing the selected most favorable transformed mesh vectors in a memory. In an example, the iterative sequence includes a recursive sequence.

The method may comprise providing the initial points in step (b) as one or more base vectors. The method may comprise obtaining the transformed mesh in step (c) via one or more isometries applied to the initial mesh of vectors and subsequent sequences of vectors. The method may comprise applying differing isometries to the initial mesh of vectors per base vector in step (c) upon determining there are multiple base vectors. The method may comprise utilizing a surrogate objective function in step (d) that, by proxy, enables an approximate or exact evaluation of the model objective function. The method may comprise determining the most favorable transformed mesh vectors in step (e) via objective function evaluations or surrogate function evaluations. The method may comprise repeating any subset of steps (a) through (e), or the entire set of steps (a) through (e), until the termination criterion is met. The termination criterion may comprise one or more thresholds for one or more of a number of objective function evaluations or surrogate function evaluations; vector magnitudes of the transformed mesh; an execution time of the method as implemented in a computing environment; a convergence tolerance of one or more base vectors; a convergence tolerance of the objective function evaluations or surrogate function evaluations; or the objective function evaluations or surrogate function evaluations. The method may comprise performing one or more steps of the method in parallel and distributed computing environments.

Another embodiment provides one or more non-transitory computer readable storage mediums storing one or more sequences of instructions, which when executed by one or more computer processors, performs a computerized optimization method for performing pattern searching, the method comprising (a) providing an initial mesh of vectors; (b) providing initial points to be used as a base vector establishing a center region of the mesh of vectors; (c) for each base vector, obtaining a transformed mesh via an isometric transformation of the initial mesh of vectors; (d) evaluating the model objective function via each transformed mesh of vectors; (e) selecting a next set of base vectors by selecting a most favorable set of transformed mesh vectors to correspond with the objective function; (f) repeating steps (c) through (e) in an iterative sequence until a termination criterion of the iterative sequence is met; and (g) storing the selected most favorable transformed mesh vectors in a memory. In an example, the iterative sequence includes a recursive sequence.

The method may comprise providing the initial points in step (b) as one or more base vectors. The method may comprise obtaining the transformed mesh in step (c) via one or more isometries applied to the initial mesh of vectors and subsequent sequences of vectors. The method may comprise applying differing isometries to the initial mesh of vectors per base vector in step (c) upon determining there are multiple base vectors. The method may comprise utilizing a surrogate objective function in step (d) that, by proxy, enables an approximate or exact evaluation of the model objective function. The method may comprise determining the most favorable transformed mesh vectors in step (e) via objective function evaluations or surrogate function evaluations. The method may comprise repeating any subset of steps (a) through (e), or the entire set of steps (a) through (e), until the termination criterion is met. The termination criterion may comprise one or more thresholds for one or more of a number of objective function evaluations or surrogate function evaluations; vector magnitudes of the transformed mesh; an execution time of the method as implemented in a computing environment; a convergence tolerance of one or more base vectors; a convergence tolerance of the objective function evaluations or surrogate function evaluations; or the objective function evaluations or surrogate function evaluations. The method may comprise performing one or more steps of the method in parallel and distributed computing environments.

Another embodiment provides a computer-implemented system for executing a computerized optimization for performing pattern searching, the system comprising a memory; and a processor that executes the computerized optimization by (a) providing an initial mesh of vectors; (b) providing initial points to be used as a base vector for establishing a center region of the mesh vectors; (c) for each base vector, obtaining a transformed mesh via an isometric transformation of the initial mesh of vectors and subsequent sequences of vectors; (d) evaluating the model objective function via each transformed mesh of vectors; (e) selecting a next set of base vectors by selecting a most favorable set of transformed mesh vectors to correspond with the objective function; (f) repeating steps (c) through (e) in an iterative sequence until a termination criterion of the iterative sequence is met; and (g) storing the selected most favorable transformed mesh vectors in the memory. In an example, the iterative sequence includes a recursive sequence. The system may comprise a plurality of processors that execute the computerized optimization method in a parallel or distributed manner.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A illustrates the standard direct search mesh in dimension 2.

FIG. 1B illustrates the process by which the standard direct search mesh may select and move to the next iterate.

FIG. 1C illustrates an embodiment herein whereby the standard mesh is rotated by π/4 radians.

FIG. 2 shows a flowchart depicting steps taken to practice an embodiment herein.

FIG. 3 illustrates four isometries of a regular simplex in dimension 2.

FIG. 4 shows a combination flowchart and block diagram depicting steps taken to practice an embodiment herein in a multi-device technical computing environment.

FIG. 5 shows eight embodiments of scaling functions that parameterize the iteration index of the direct search.

FIG. 6 shows eight embodiments of scaling functions similar to those shown in FIG. 5 but with a different trigonometric function multiplier.

FIG. 7 illustrates a block diagram of an example computer system used with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein overcome the deficiencies of the conventional solutions and address the aforementioned challenges of optimization by developing and providing an improved direct search process wherein, at each iteration, an isometric transformation is applied to the mesh.

Applications

Methods of optimization for the above-mentioned problems are useful in a variety of applications, including, but not limited to: machine learning, molecular modeling, mechanics and mechanical engineering, electrical engineering, economics and finance, control engineering, and systems biology. Of particular interest is the application to machine learning, which often involves a machine learning algorithm operating in conjunction with an optimization algorithm. The optimization algorithm is critical to the success of the machine learning model, and different optimization algorithms can dramatically affect the machine learning results. Such applications can be highly dimensional and often exceed computing resources and reasonable time. Therefore, fast optimization algorithms are typically employed, but they often yield suboptimal results. Moreover, the common optimization algorithms are generally stochastic, localized, and require function derivatives. For example, artificial neural networks, a popular set of machine learning algorithms, are typically used in conjunction with the Backpropagation of Errors algorithm, which is stochastic, localized, and requires function derivatives. The embodiments herein address these problematic characteristics of the conventional solutions. Although the embodiments herein may be applied in multiple applications, such that it may yield solutions to the aforementioned general optimization problem, application to problems with inherent high dimensionality, such as machine learning, are emphasized as exemplary application.

Iterative Optimization

Optimization processes are often iterative such that, given an initial vector in n-dimensional space, a sequence of vectors is iteratively generated to solve the optimization problem. The sequence of iterates is often generated until some termination criteria are met. Common termination criteria include but are not limited to: limited objective function evaluations, limited length of the sequence of iterates, limited time for the optimization process, convergence of the optimization algorithm on a set of vectors, and a threshold for objective function evaluations.

Gradient Methods

One of many examples of such iterative methods are gradient descent algorithms, which generate the next iterate by gradually stepping down the gradient of the objective function evaluated at each iterate. This can be expressed in the general form xₜ₊₁=xₜ−α∇ƒ(xₜ) where xₜ is the current iterate, xₜ₊₁ is the next iterate, ∇ƒ(xₜ) is the gradient of the objective function at the current iterate, and α is a scalar that determines the step length along the gradient. The step size, α, is often optimized at each iteration by techniques such as the line-search method. This general form represents a first-order iterative optimization algorithm. Second order methods are also commonly deployed iterative optimization algorithms. For example, Newton's method locally approximates the objective function as a quadratic by second-order Taylor series in the form: xₜ₊₁=xₜ−α(∇² ƒ(xₜ))⁻¹∇ƒ(xₜ). Thus, in this general form, the Hessian is computed at each iterate. Although increasing the order of the Taylor series can better approximate the function, doing so increases computational demand. Moreover, the first-order and second-order methods generally require that the function be differentiable or twice differentiable, respectively. Where some methods can approximate the gradient of non-differentiable functions, such as the quasi-Newton method, zero-order optimization precludes such extra computation altogether by ignoring gradient information. Thus zero-order optimization is generally more robust as the objective function need not be differentiable nor continuous.

Direct Search Optimization

A class of zero-order optimization algorithms, called direct search methods, are able to scale linearly with respect to dimensionality while maintaining decent optimization efficacy. Other names exist for this method, including, but not limited to: pattern search, derivative-free search, and black-box search.

The direct search algorithm generates a sequence of iterates similar to the gradient descent methods. Unlike the gradient methods, however, the direct search algorithm finds the successive iterates by sampling a neighborhood region about the current iterate. Thus, given a starting base point x₀, the algorithm samples the neighborhood about x₀ and designates the point that yields the minimum objective function value as the new base point x₁. This cycle repeats until some termination criterion is met.

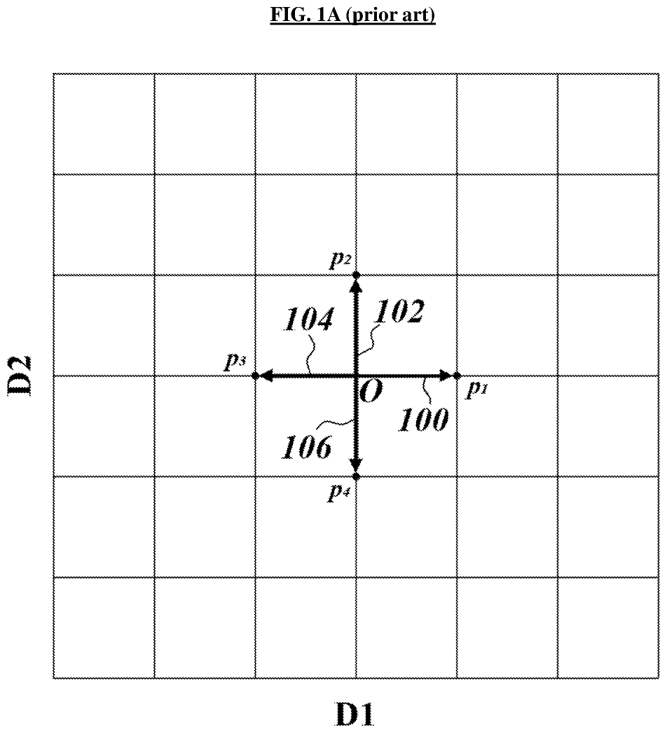

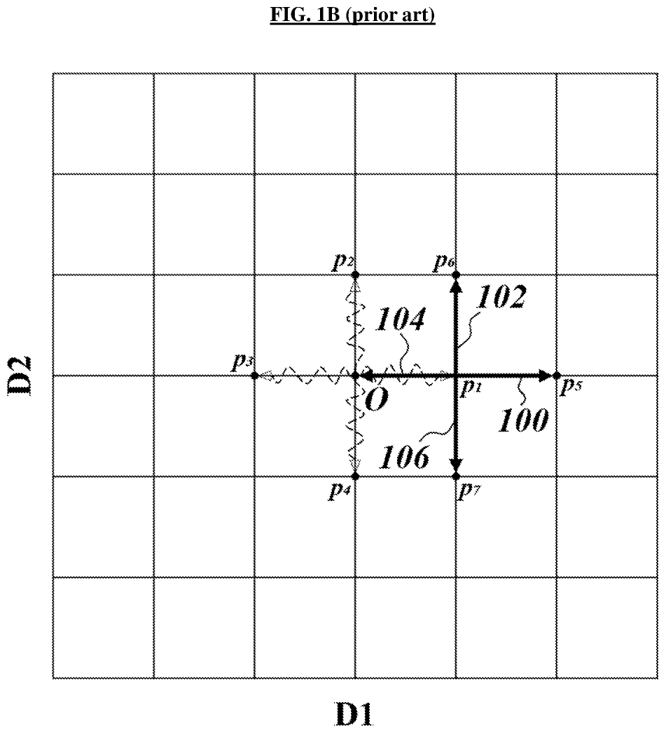

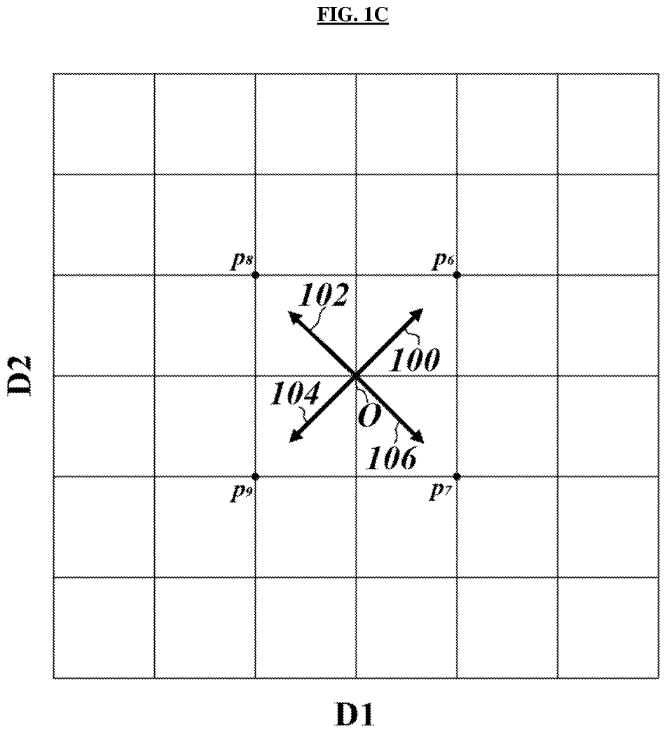

The sampling technique is commonly performed using a set of vectors, called a mesh. Multiple methods can generate a mesh. For example, in n dimensions, using the unit orthoplex vertices defines a maximal positive basis of 2n vectors that allows movement in each direction of all dimensions. This defines a mesh generation protocol that is linear with respect to dimensionality, therefore desirable for scalability. An example of this mesh is centered about point O illustrated in FIG. 1A. The process of selecting the next iterate is then depicted in FIG. 1B. In this example, point p₁, designated by mesh vector 100, yielded the minimum objective function value out of the four initially evaluated points: p₁, p₂, p₃, and p₄, designated by mesh vectors 100, 102, 104, and 106, respectively. In this example, only a single sequence is generated, but it is possible that multiple concurrent sequences are generated by selecting multiple best points. Then, for each selected point, the mesh is centered about the selected point as illustrated in FIG. 1B. From there, the sequence may continue by evaluating points p₅, p₆, p₇, and O, designated by mesh vectors 100, 102, 104, and 106 respectively center at point p₁. In this manner, the mesh can explore the D1-D2 plane and search for the minimum objective function value. This process and particular mesh composition are generalizable to higher dimensions.

A more holistic mesh can be formed by the vertices of the unit hypercube, but instead of 2n vectors, this mesh would be composed of 2ⁿ vectors. The combinatorial nature of such mesh vectors allows for greater maneuverability; however, the exponential increase in mesh size makes this method often infeasible for use in high dimensions.

Mesh generation can also be a stochastic process whereby vectors are generated by sampling a probability distribution function, including, but not limited to, the uniform distribution and normal distribution. Random uniform sampling of a hypersphere about the current iterate is often called a Random Search. Random sampling of the normal distribution about the current iterate is often called Random Optimization. These methods can help to overcome local minima by introducing random perturbations to an otherwise static mesh.

Unlike the standard mesh composed of 2n vectors, illustrated in FIG. 1A, the embodiments herein repeatedly generate vectors by applying a combination of isometric transformations to the mesh. And unlike the mesh of 2ⁿ vectors that represent all combinations of orthogonal movement, the embodiments herein achieve holistic search capabilities while not requiring exponential growth with respect to dimensionality. Moreover, unlike the conventional solutions that utilize stochastic mesh generation, the embodiments herein can utilize a hypergeometric mesh based on polytopic features; thus, the isometries preserve many critical features of the mesh throughout the iterative optimization process. This allows the results achieved by the embodiments herein to be deterministically reproducible.

To demonstrate one embodiment of an isometric transformation applied to a mesh, FIG. 1C illustrates the unit orthoplex rotated by π/4 radians about point O. From FIG. 1A, vectors 100, 102, 104, and 106 initially yield points p₁, p₂, p₃, and p₄, respectively. After rotation, as illustrated in FIG. 1C, vectors 100, 102, 104, and 106 yield points p₆, p₈, p₉, and p₇, respectively. This embodiment enables the mesh to move along the diagonals of the search space per iteration. This transformation preserves the polytopic properties of the unit orthoplex, including the L² distance between each point, the L² distance of each point to the centroid, and each dihedral angle of the polytope. Therefore, all proportions that define the polytope are preserved.

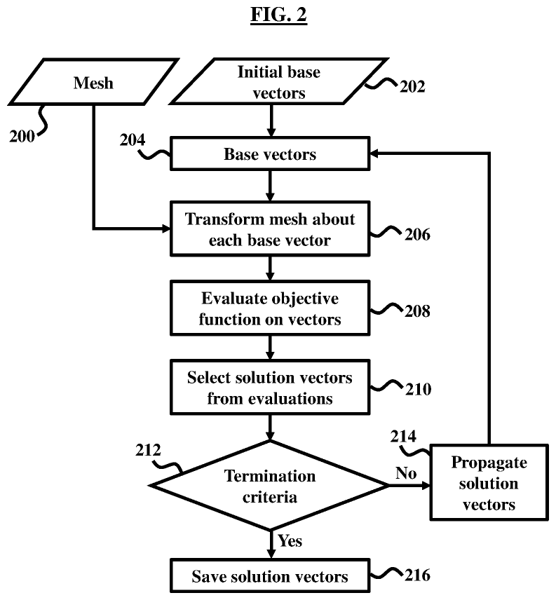

An example of the algorithm is shown in the process flow diagram of FIG. 2. An initial mesh is generated at block 200. Additionally, initial base vectors are generated at block 202 which, for the first iteration, are designated as the current iterate base vectors at block 204. The isometric transformations are applied to the mesh and imposed upon each base vector at block 206. Such transformations may include rotations, reflections, translations, and scaling of the mesh. If there exist multiple base vectors, the mesh is copied prior to transformation such that each base vector receives a mesh. Generally, transformation about a base vector entails centering the mesh at the base vector. However, in other cases, the mesh may not be centered about the base vector but is instead translated according to a function that parameterizes the base vector. A transformed mesh represents the vectors to be evaluated by the objective function at block 208. After evaluating each of these vectors, the vectors with lowest objective function values are selected at block 210. If a termination criterion is not met at block 212, then the selected propagated solution vectors of block 214 are designated as the new base vectors at block 204 such that the process may repeat. If a termination criterion is met at block 212, then the selected vectors are saved at block 216 as the output of the algorithm.

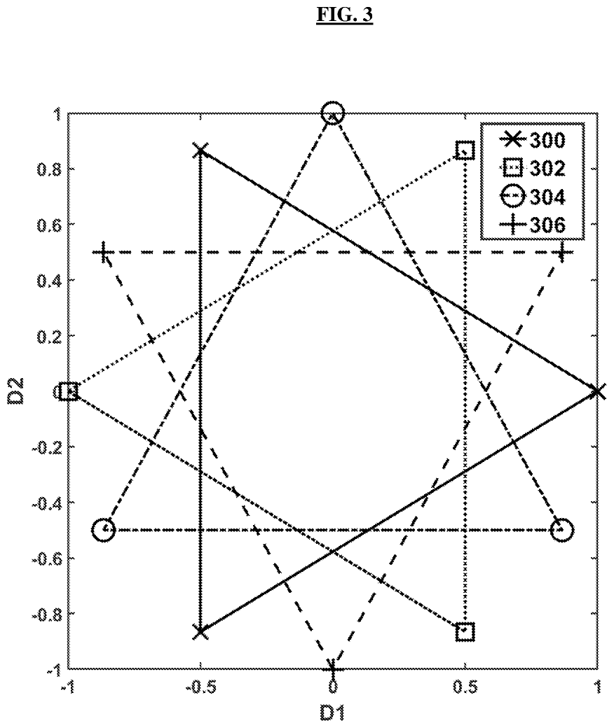

In FIG. 3, the vertices of a regular simplex in dimension 2 comprise the mesh 300. Therefore, the edges of the simplex are visualized to best illustrate the geometric interpretation of the mesh. There are also multiple useful isometries in FIG. 3. In particular, where the simplex is centered at the origin point O, 302 represents a reflection about the D2 axis. This reflection is functionally identical to rotation by π radians or scaling by −1. Similarly, 304 is a rotation of 300, but by a value a different number of radians. The last of the four embodied simplex isometries is 306, which, among infinite possible transformations, can be considered, but is not limited to, a reflection of 304 about the D1 axis. These four simplices demonstrate the ability of isometric transformations to preserve the polytopic properties of the original regular simplex 300, while introducing additional search directions. Additionally, the isometric transformations ensure that the simplex remains regular such that each dihedral angle remains equal to cos⁻¹(1/n) and that each vector is equidistant to the center and each other.

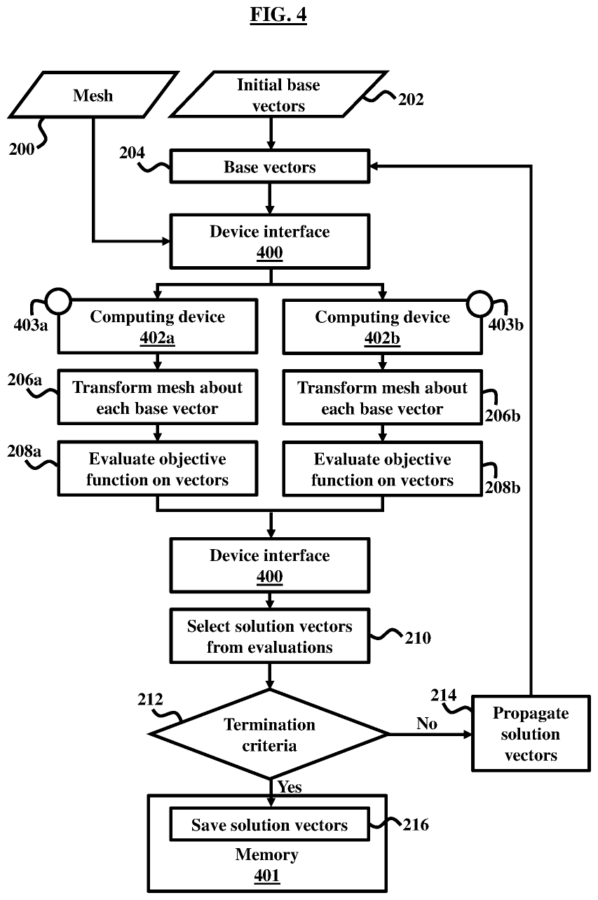

In another embodiment herein, the processes and methods described herein may be conducted in a distributed computing environment. Those skilled in the art would appreciate the capability for the embodiments herein to be parallelized, distributed, or a combination of parallelized and distributed, in a technical computing environment comprised of multiple devices. As illustrated in FIG. 4, the embodiments herein may use a multi-device interface 400 to offload work to peripheral devices 402a, 402b. The devices 402a, 402b may then execute part of the algorithm in parallel (e.g., blocks 206a, 206b and blocks 208a, 208b), which may improve execution time and thereby reduce processing loads and requirements. For example, in each iteration, the mesh generation is offloaded by the multi-device interface 400, to multiple devices 402a, 402b, so that each device may transform the mesh, at blocks 206a, 206b, and evaluates the objective function at blocks 208a, 208b, on the current iterate points. After parallel execution, the devices 402a, 402b communicate their results to the multi-device interface 400 so that the algorithm loop may continue until the solution vectors of block 216 are stored in memory 401.

Each device 402a, 402b may evaluate the entire mesh or a subset of the mesh. When the data defining the entire mesh exceeds the storage capacity of the device storage medium, each device 402a, 402b may operate on a subset of the overall mesh. If external data is necessary to evaluate the objective function but the external data exceeds the storage capacity of a single device storage medium, the devices 402a, 402b may cooperate such that subsets of the external data are loaded onto each device 402a, 402b.

In an exemplary embodiment, the various blocks described herein and illustrated in the figures may be embodied as hardware-enabled computer modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The blocks or modules that are configured with electronic circuits process computer logic instructions capable of providing at least one digital signals or analog signals for performing various functions as described herein. The various functions can further be embodied and physically saved as any of data structures, data paths, data objects, data object models, object files, database components. For example, the data objects could be configured as a digital packet of structured data. The data structures could be configured as any of an array, tuple, map, union, variant, set, graph, tree, node, and an object, which may be stored and retrieved by computer memory and may be managed by processors, compilers, and other computer hardware components. The data paths can be configured as part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be configured as physical locations in computer memory and can be a variable, a data structure, or a function. In the embodiments configured as relational databases (e.g., such as Oracle® relational databases), the data objects can be configured as a table or column. Other configurations include specialized objects, distributed objects, object-oriented programming objects, and semantic web objects, for example. The data object models can be configured as an application programming interface for creating HyperText Markup Language (HTML) and Extensible Markup Language (XML) electronic documents. The models can be further configured as any of a tree, graph, container, list, map, queue, set, stack, and variations thereof. The data object files are created by compilers and assemblers and contain generated binary code and data for a source file. The database components can include any of tables, indexes, views, stored procedures, and triggers.

The devices 402a, 402b may be configured as computing devices comprising processors 403a, 403b that may comprise any of an integrated circuit, an application-specific integrated circuit (ASIC), field-programmable gate array (FPGA), a microcontroller, a microprocessor, an ASIC processor, a digital signal processor, a networking processor, a multi-core processor, or other suitable processors selected to be communicatively linked to the sensor. In some examples, the processors 403a, 403b may comprise a CPU of the devices 402a, 402b. In other examples the processors 403a, 403b may be a discrete component independent of other processing components in the devices 402a, 402b. In other examples, the processors 403a, 403b may be a microcontroller, hardware engine, hardware pipeline, and/or other hardware-enabled device suitable for receiving, processing, operating, and performing various functions required by the devices 402a, 402b. The processors 403a, 403b may be provided in the devices 402a, 402b, or other devices coupled to the devices 402a, 402b, or communicatively linked to the devices 402a, 402b from a remote networked location, according to various examples.

The processors 403a, 403b may be configured for retrieval and execution of instructions stored in a machine-readable storage medium such that the processors 403a, 403b may fetch, decode, and execute computer-executable instructions to enable execution of locally-hosted or remotely-hosted applications for controlling action of the devices 402a, 402b. The remotely-hosted applications may be accessible on one or more remotely-located devices (not shown). For example, the remotely-located devices may be a computer, tablet, smartphone, or remote server. As an alternative or in addition to retrieving and executing instructions, processor may include one or more electronic circuits including a number of electronic components for performing the functionality of one or more of the computer-executable instructions.

The processing techniques performed by the processors 403a, 403b may be implemented as one or more software modules in a set of logic instructions stored in a machine or computer-readable storage medium such as random-access memory (RAM), read only memory (ROM), programmable ROM (PROM), firmware, flash memory, etc. in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out processing operations performed by the processor may be written in any combination of one or more programming languages.

In an example, the embodiments herein can provide a computer program product configured to include a pre-configured set of instructions, which when performed, can result in actions as stated in conjunction with various figures herein. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may also include tangible and/or non-transitory computer-readable storage media for carrying or having computer-executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a special purpose computer or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network. If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips including computer products having a display, a keyboard or other input device, and a central processor.

The embodiments herein take a different approach to optimization by geometrically deconstructing the search space and using a mesh to evaluate the function at several points in the search space to find a reasonable solution vector. The function is first evaluated at each point of the initial mesh which is centered about the centroid of the search space. Then, the points with the lowest function evaluations are designated as the new center points. According to some examples, the mesh may then be transformed via scaling, reflection, rotation, or a combination of these operations before the next iteration. If new center points are found, the mesh transformations may include translations about each new center point. Multiple center points can be used by copying the mesh and centering each copy about a unique center point. This process repeats until a termination condition is reached.

In one embodiment, the unit orthoplex vertices are used to construct the mesh. The unit orthoplex vertices generate a notable mesh due to Kusner's conjecture, which demonstrates that the mesh is the largest equidistant set in the L¹ metric space, so the content coverage is maximized while maintaining linear set cardinality with respect to dimensionality. The unit orthoplex can be expanded by rotating and then inscribing the polytope within the search space, which is often the unit-hypercube, but can be considered any n-dimensional rectangular prism. The rotated orthoplex mesh component values, unlike the unit orthoplex mesh, are not sparse; the rotations yield many nonzero values whereas the unit orthoplex vertex components are all zero except for a single dimension, which has a component value of either 1 or −1. Many methods can rotate the orthoplex; one such exemplary method is outlined below:

```
Input: n ← dimension
  [a, b] ← vertex index bounds
    θ ← rotation angle
Output: M ∈ [−1, 1]^{n×2(b-a)} ← mesh
```

| | |
|---|---|
| 1. | c ← b − a |
| 2. | M ← [[0]^{c×a} \|I_{c}\| [0]^{c×(n-b)}] |
| 3. | for d₀ ∈ {1, 2, ... , n} |
| 4. | for d₁ ∈ {n, n-1, ... 1} \ {d₀} |
| 5. | \vec{v} ← M_{{1,2,...c},d}_{₀} |
| 6. | \vec{w} ← M_{{1,2,...c},d}_{₁} |
| 7. | M_{{1,2,...c},d0} ← \vec{w} sin(θ) + \vec{v} cos(θ) |
| 8. | M_{{1,2,...c},d1} ← \vec{w} cos(θ) − \vec{v} sin(θ) |
| 9. | end for |
| 10. | end for |
| 11. | $M ← [ \frac{{M}_{{\{ 1 , 2 , … , c \}}_{{ }^{, y}}}}{max ( \{ \vert x \vert ∈ {M}_{{\{ 1 , 2 , … , c \}}_{{ }^{, y}}} \} )} ∀ y ∈ \{ 1 , 2 , … , n \} ]$ |
| 12. | M ← {M^{T}\| − M^{T}] |

whereby the orthoplex points are rotated iteratively in planes spanned by 2-dimension axes. In this embodiment, pairs of dimensions are selected for rotation in a doubly nested for-loop. Where {d₀,d₁}∈{1, 2, . . . n} such that d₀ is the outer for-loop index and d₁ is the inner for-loop index, rotation planes are chosen by iterating d₀ forward and by iterating d₁ backward. Thus d₀ increments by 1 from 1 to n and d₁ decrements by 1 from n to 1. When d₀=d₁, a rotation plane cannot be formed by dimensions d₀ and d₁, so the inner for-loop skips to the next iterate. After the rotations, the row vectors are inscribed within the unit hypercube prior and then transposed so that the mesh vectors are read in column major format.

Another embodiment demonstrates a method by which multiple solution vectors can be retrieved. The general framework for such procedure is outlined below:

```
Input: M [symbol]     mesh
  Δ [symbol]     mesh transform function
  ϕ [symbol]     objective function
  n [symbol]     objective function dimensionality
  c [symbol]     number of iterations to execute direct search
Output: P* [symbol]     solution vectors
1. P* [symbol]     0
2. for i ∈ {1, 2, ... c}
3.  M′ [symbol]     {Δ(M(n, i), n, i) + P*ₓ,∀ × ∈ {1, 2, ..., |P*|}}
4.  P* [symbol]     selectOptimal(ϕ, {P* ∪ M′})
5. end for
```

This embodiment produces a set of column vectors corresponding to a set of the vertices of the orthoplex. The algorithm starts with an identity matrix with rows and columns equal to the number of dimensions to represent the half of the orthoplex with nonnegative vertices. Additionally, this algorithm is dynamic so that vertices can be selectively processed rather than processing the entire orthoplex at once. Then, for every pair of row vectors in the matrix the algorithm iterates through the columns to rotate the matrix within the plane created by those two dimensions. After this rotation process, each row vector is then divided by the maximum element of the row to expand the vector to a facet of the unit hypercube. Finally, the matrix negative is appended to get the opposing vertices of the half orthoplex. Since this algorithm can generate specific vertices of a rotated orthoplex, it is able to be parallelized by having different computing mediums generate different parts of the orthoplex to either combine later or to operate upon independently.

In another embodiment, two regular simplices are used to search a unit-hypercube. Like the orthoplex, this embodiment ensures linear scaling with respect to dimension while having a variety of search directions. However, the simplex takes significantly fewer operations to generate than the orthoplex and requires less storage space in the computing medium. Furthermore, in this embodiment the mesh is only shrunk and reflected each iteration, which is much faster than rotation. Thus, this embodiment is more optimized for computing environments. The algorithm for generating this embodiment is outlined below:

Input: n ← dimension
Output: M ∈ [−1, 1]^{n×2(n+2)} ← mesh

| | |
|---|---|
| 1. | M ← [0_{n×n+1}] |
| 2. | M_{1,1} = 1 |
| 3. | ${M}_{1 , \{ 2 , 3 , … , n + 1 \}} = - \frac{1}{n}$ |
| 4. | for c ∈ {2, 3, ... , n} |
| 5. | ${M}_{c , c} ← \sqrt{1 - {\sum }_{i = 1}^{c - 1} {M}_{i , c}^{2}}$ |
| 6. | ${M}_{c , \{ c + 1 , c + 2 , … , n + 1 \}} ← - \frac{1}{{M}_{c , c}} ( \frac{1}{n} + {M}_{{\{ 1 , 2 , … , n \}}_{{ }^{, c}}} \cdot {M}_{{\{ 1 , 2 , … , n \}}_{{ }^{, c + 1}}} )$ |
| 7. | end for |
| 8. | M ← [M\| − M_{{n,n-1,...,1},{1,2,...,n+1}}] |

This method produces a set of column vectors corresponding to the entire double simplex. For a regular simplex, the distance from each vertex to the center is the same, and when centered about the origin, dot product of any two vertices is −1/n. Combining these facts with the assumption that all elements below the main diagonal of the matrix are zero allows the algorithm to generate an entire simplex. The first row is initialized with a 1 in the first column and −1/n in the rest. The algorithm then moves down the rows, where for each row it sets the value on the main diagonal to ensure the norm of the vector is 1 before setting the remaining values to the right of that element in the row to ensure the dot product of that vector and all following vectors is −1/n. After all rows have been processed in the above manner, a regular simplex is produced, and a negative copy of that simplex with the rows reversed is appended to create the double simplex matrix. Reversing the rows in this manner maintains the properties of a simplex and thus results in a rotation of the original simplex. One property of the original simplex generated by this algorithm is that every row above the main diagonal has a constant value, so storing this simplex only requires storing the main diagonal and the diagonal above it. Since calculating the double simplex from the original simplex is straightforward, no significant extra storage is required for that process either. The points generated by the 2-dimensional version of this embodiment are illustrated in FIG. 3

Another embodiment utilizes a mesh generated from the vertices of a single simplex, thus comprised of n+1 points. This mesh defines a minimal positive basis, thus enabling movement in all directions while requiring few objective function evaluations per iteration. It is generated similar to the above embodiment but does not include the final matrix augmentation via the negative simplex. One aspect of using the simplex for the direct search is that isometric transformations are quickly and easily computed. In particular, rotation is achievable by swapping rows of the above-defined matrix, as it preserves the properties of a regular simplex. For instance, swapping the first and second rows of the matrix represents an isometric transformation whereby the original mesh is rotated yet preserves the geometric properties of the regular simplex. This powerful method can introduce many combinations of mesh vector directions without significant computational complexity. Swapping multiple rows can enable any permutation of the rows, and is achievable via shuffling, which consists of selective indexing of the original mesh, or any already shuffled instance of the mesh. Moreover, such rotations can be used to selectively search dimensions with greater or fewer sparse elements. Where the original mesh contains a lower left triangle of zeros shuffling the rows can enable the mesh to adapt to the iteration evaluations. Because the diagonal of the initial mesh contains the component of greatest absolute magnitude per column, the row of these components lends a one-to-one mapping from column to dimension. The ultimate and penultimate columns are coupled because their greatest absolute magnitude components are in the same row. This mapping property of the regular simplex generated by the above-outlined methods can enable selective shuffling, thus rotation, to intelligently explore the search space according to the objective function evaluations per point. If, for example, a point yields the highest objective function evaluation in a given iteration, the simplex may rotate such that the next mesh has fewest sparse elements in the dimension containing the greatest absolute magnitude of said point. Selective rotation via shuffling of the simplex is not limited to the aforementioned method; for instance, the mesh may rotate to provide aforementioned selected dimension with the sparsest elements, which consequently yields the highest magnitude component of the mesh to that dimension, possibly enabling escape from local minima.

In another embodiment, another set of points are derived from the double simplex but uses a total of 2n instead where the double regular simplices are defined by a total of 2n+2 points, another set of points are derived from the double simplex but uses a total of 2n instead. This 2n set removes the last point in each of the simplices in the double simplex. This lets the 2n set form a matrix containing a lower triangle of zeros, a diagonal of high magnitude components, and an upper triangle of nonzero but low magnitude components. The original double simplex is identical except with the additional column of nonzero components. Because the set of 2n points are generated from n points and their negatives, the final column of the original double simplex can be removed without altering the total number of unique directions between the 2n set and the 2n+2 set. This is because the final column and its negative are redundant with the penultimate column and its negative with regard to each row corresponding to the diagonal forming columns which uniquely possess high magnitude components in their transposed row.

Where the above-mentioned embodiments demonstrate geometric mesh generation via rotation and reflection, scaling also comprises another embodiment. A variety of functions can be used to scale the mesh per iteration. Such functions include, but are not limited to:

$${Δ}_{0} ( i ) = {σ}^{\frac{2 ( i - 1 )}{I - 1}} \\ {Δ}_{1} ( i ) = 1 + \frac{i - 1}{I - 1} ( {σ}^{2} - 1 ) \\ {Δ}_{2} ( i ) = 1 + {σ}^{2} - {σ}^{\frac{2 ( I - i )}{I - 1}} \\ {Δ}_{3} ( i ) = {Δ}_{1} - min [ {Δ}_{2} - {Δ}_{1} , {Δ}_{1} - {Δ}_{0} ] sin ( \frac{2 π i}{I} ) \\ {Δ}_{4} ( i ) = {Δ}_{1} + ( sign [ \vert min ( {Δ}_{3} - {Δ}_{2} , 0 ) \vert ] ( {Δ}_{2} - {Δ}_{1} ) + sign [ max ( {Δ}_{3} - {Δ}_{1} , 0 ) ] ( {Δ}_{1} - {Δ}_{0} ) ) sin ( \frac{2 π i}{I} ) \\ {Δ}_{5} ( i ) = \frac{( {Δ}_{1} + {Δ}_{0} )}{2} + \frac{( {Δ}_{1} - {Δ}_{0} )}{2} sin ( \frac{2 π i}{I} ) \\ {Δ}_{6} ( i ) = \frac{{Δ}_{2} + {Δ}_{1}}{2} + \frac{{Δ}_{2} - {Δ}_{1}}{2} sin ( \frac{2 π i}{I} ) \\ {Δ}_{7} ( i ) = \frac{{Δ}_{0} + {σ}^{2}}{2} + \frac{{Δ}_{0} - {σ}^{2}}{2} sin ( \frac{2 π i}{I} ) \qquad$$

where n:=dimension, σ²:=⅓n, i:=iteration∈[1, I], I:=total iterations.

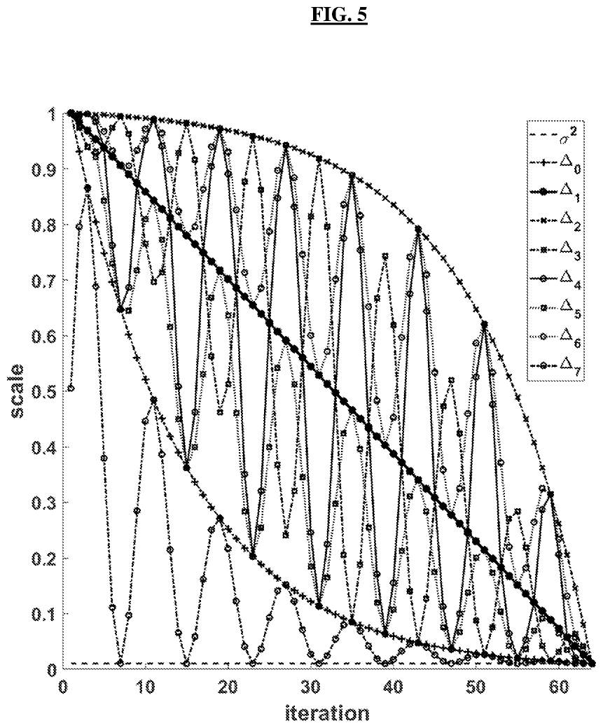

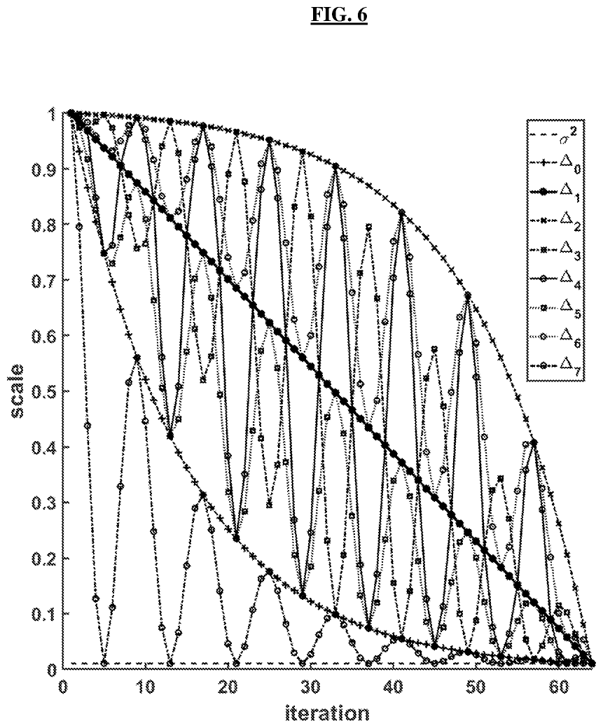

These functions are plotted in FIG. 5 and for n=32 and I=64. The sin (2πi/I) terms may be replaced with cos (2πi/I), as demonstrated in FIG. 6. The value σ⁻² represents the variance of the mean value of n independent uniform distributions in the domain [a, b]. This is calculable from the Bates Distribution probability density function, where

$$r = \frac{n ( x - a )}{b - a} - k \text{:}$$

$$PDF ( n , x , a , b ) = \frac{n}{2 ( n - 1 ) ! ( b - a )} {\sum }_{k = 0}^{n} ( {( - 1 )}^{k} ( \begin{matrix}n \\ k\end{matrix} ) {r}^{n - 1} sign ( r ) ) ∀ \{ x ∈ [ b , a ] , n ∈ [ 1 , ∞ ) \}$$

$$Variance ( n , x , a , b ) = \frac{{( b - a )}^{2}}{12 n}$$

Given the unit hypercube domain, [a, b]=[−1, 1]∴Variance(n, r, a, b)=⅓n. Therefore, the above functions yield values greater than the variance of the mean n independent variables sampled from the uniform distribution across each search space dimension. This process prevents the mesh from becoming too small. Where the first iteration yields the largest mesh size multiplier of 1, the final iteration yields the smallest mesh size multiplier, which is equal to σ². Considering the domain of the unit hypercube as a lattice, specifically a hypercubic tessellation, one may discretize the continuous search space by tiling with cell side lengths equal to σ². This discretization thus assumes no prior knowledge about the objective function.

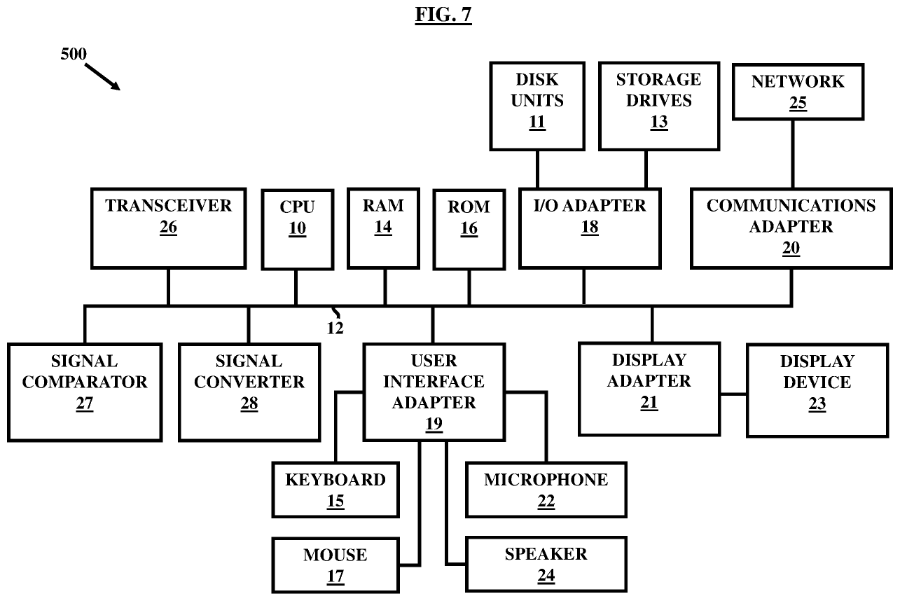

A representative hardware environment for practicing the embodiments herein is depicted in FIG. 7. This schematic drawing illustrates a hardware configuration of an information handling/computer system 500 in accordance with the embodiments herein. The system 500 comprises at least one processor or central processing unit (CPU) 10. The CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system 500 can read the inventive instructions on the program storage devices and follow these instructions to execute the methodology of the embodiments herein. The system 500 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network, and a display adapter 21 connects the bus 12 to a display device 23 which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electronic signals.

Direct search optimization algorithms can converge to suboptimal solutions, which is often caused by the mesh limiting sufficient exploration of the search space. The embodiments herein address this problem by applying isometric transformations to the mesh at each iteration of the algorithm, effectively expanding the search capability of the mesh. Additionally, the embodiments herein develop hyperdimensional geometries to best explore the search space while making efficient use of the isometries.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A computerized optimization method for performing pattern searching, the method comprising:
(a) providing an initial mesh of vectors;
(b) providing initial points to be used as a base vector establishing a center region of the mesh of vectors;
(c) for each base vector, obtaining a transformed mesh via an isometric transformation of the initial mesh of vectors;
(d) evaluating the model objective function via each transformed mesh of vectors;
(e) selecting a next set of base vectors by selecting a most favorable set of transformed mesh vectors to correspond with the objective function;
(f) repeating steps (c) through (e) in an iterative sequence until a termination criterion of the iterative sequence is met; and
(g) storing the selected most favorable transformed mesh vectors in a memory.

2. The method of claim 1, comprising providing the initial points in step (b) as one or more base vectors.

3. The method of claim 1, comprising obtaining the transformed mesh in step (c) via one or more isometries applied to the initial mesh of vectors and subsequent sequences of vectors.

4. The method of claim 1, comprising applying differing isometries to the initial mesh of vectors per base vector in step (c) upon determining there are multiple base vectors.

5. The method of claim 1, comprising utilizing a surrogate objective function in step (d) that, by proxy, enables an approximate or exact evaluation of the model objective function.

6. The method of claim 5, comprising determining the most favorable transformed mesh vectors in step (e) via objective function evaluations or surrogate function evaluations.

7. The method of claim 1, comprising repeating any subset of steps (a) through (e), or the entire set of steps (a) through (e), until the termination criterion is met.

8. The method of claim 5, wherein the termination criterion comprises one or more thresholds for one or more of:
a number of objective function evaluations or surrogate function evaluations;
vector magnitudes of the transformed mesh;
an execution time of the method as implemented in a computing environment;
a convergence tolerance of one or more base vectors;
a convergence tolerance of the objective function evaluations or surrogate function evaluations; or
the objective function evaluations or surrogate function evaluations.

9. The method of claim 1, comprising performing one or more steps of the method in parallel and distributed computing environments.

10. One or more non-transitory computer readable storage mediums storing one or more sequences of instructions, which when executed by one or more computer processors, performs a computerized optimization method for performing pattern searching, the method comprising:
(a) providing an initial mesh of vectors;
(b) providing initial points to be used as a base vector establishing a center region of the mesh of vectors;
(c) for each base vector, obtaining a transformed mesh via an isometric transformation of the initial mesh of vectors;
(d) evaluating the model objective function via each transformed mesh of vectors;
(e) selecting a next set of base vectors by selecting a most favorable set of transformed mesh vectors to correspond with the objective function;
(f) repeating steps (c) through (e) in an iterative sequence until a termination criterion of the iterative sequence is met; and
(g) storing the selected most favorable transformed mesh vectors in a memory.

11. The one or more non-transitory computer readable storage mediums storing one or more sequences of instructions of claim 10, which when executed by the one or more computer processors further causes providing the initial points in step (b) as one or more base vectors.

12. The one or more non-transitory computer readable storage mediums storing one or more sequences of instructions of claim 10, which when executed by the one or more computer processors further causes obtaining the transformed mesh in step (c) via one or more isometries applied to the initial mesh of vectors and subsequent sequences of vectors.

13. The one or more non-transitory computer readable storage mediums storing one or more sequences of instructions of claim 10, which when executed by the one or more computer processors further causes applying differing isometries to the initial mesh of vectors per base vector in step (c) upon determining there are multiple base vectors.

14. The one or more non-transitory computer readable storage mediums storing one or more sequences of instructions of claim 10, which when executed by the one or more computer processors further causes utilizing a surrogate objective function in step (d) that, by proxy, enables an approximate or exact evaluation of the model objective function.

15. The one or more non-transitory computer readable storage mediums storing one or more sequences of instructions of claim 14, which when executed by the one or more computer processors further causes determining the most favorable transformed mesh vectors in step (e) via objective function evaluations or surrogate function evaluations.

16. The one or more non-transitory computer readable storage mediums storing one or more sequences of instructions of claim 10, which when executed by the one or more computer processors further causes repeating any subset of steps (a) through (e), or the entire set of steps (a) through (e), until the termination criterion is met.

17. The one or more non-transitory computer readable storage mediums storing one or more sequences of instructions of claim 14, which when executed by the one or more computer processors further causes establishing the termination criterion as comprising one or more thresholds for one or more of:
a number of objective function evaluations or surrogate function evaluations;
vector magnitudes of the transformed mesh;
an execution time of the method as implemented in a computing environment;
a convergence tolerance of one or more base vectors;
a convergence tolerance of the objective function evaluations or surrogate function evaluations; or
the objective function evaluations or surrogate function evaluations.

18. The one or more non-transitory computer readable storage mediums storing one or more sequences of instructions of claim 10, which when executed by the one or more computer processors further causes performing one or more steps of the method in parallel or distributed computing environments.

19. A computer-implemented system for executing a computerized optimization for performing pattern searching, the system comprising:
a memory; and
a processor that executes the computerized optimization by:
(a) providing an initial mesh of vectors;
(b) providing initial points to be used as a base vector for establishing a center region of the mesh vectors;
(c) for each base vector, obtaining a transformed mesh via an isometric transformation of the initial mesh of vectors and subsequent sequences of vectors;
(d) evaluating the model objective function via each transformed mesh of vectors;
(e) selecting a next set of base vectors by selecting a most favorable set of transformed mesh vectors to correspond with the objective function;
(f) repeating steps (c) through (e) in an iterative sequence until a termination criterion of the iterative sequence is met; and
(g) storing the selected most favorable transformed mesh vectors in the memory.

20. The system of claim 19, comprising a plurality of processors that execute the computerized optimization method in a parallel or distributed manner.
